(19) United States
(12) Patent Application Publication
(10) Pub. No.: US 2005/0023088 A1
(43) Pub. Date: Feb. 3, 2005

(54) Torque plate

(76) Inventor: Joakim Gripemark, Helsingborg (SE)

Correspondence Address: ST. ONGE STEWARD JOHNSTON & REENS, LLC, 986 BEDFORD STREET, STAMFORD, CT, 06905-5619, US

(21) Appl. No.: 10/900,741

(22) Filed: Jul. 28, 2004

Related U.S. Application Data
(63) Continuation of application No. PCT/SE03/00126, filed on Jan. 24, 2003.

(30) Foreign Application Priority Data
Jan. 28, 2002 (SE) 0200218-6

(51) Int. Cl. F16D 55/00

(52) U.S. Cl. 188/73.31; 188/71.1; 188/73.1

(57) ABSTRACT

The present invention concerns a torque plate used at a disc brake having a fixed caliper. The torque plate has a first longitudinal part, which is extended in perpendicular direction to the axial direction of a wheel axle to be received in an opening of said first part. Two angled parts are arranged at each end of the first part. The angled parts each have a raised portion, on which a support surface is arranged for contact with the caliper. The support surfaces incline in a direction towards the wheel axle.

### THIS APPLICATION IS A CONTINUATION OF PENDING INTERNATIONAL

Patent Application No. PCT/SE2003/000126 filed Jan. 24, 2003 which designates the United States and claims priority of pending Swedish Application No. 0200218-6 filed Jan. 28, 2002.

### FIELD OF THE INVENTION

1. Technical Field

The present invention concerns a torque plate used at a disc brake having a fixed caliper and one or more floating discs. The torque plate is developed for brakes for heavy-duty vehicles. However, a person skilled in the art realizes that it may be used in brakes for all kinds of vehicles.

2. Prior Art

Disc brakes are generally of two different types. One type of disc brakes have a fixed caliper and floating disc (s), while the other type have a floating caliper and fixed disc (s). The main difference between the two types is that in the first of the above types the disc (s) is moved directly into and out of contact with brake pads. In the other type of disc brake the caliper is moved to bring the brake pads into contact or out of contact with the fixed brake disc (s). Disc brakes having a floating caliper must have some kind of holder or support, allowing the movement of the caliper. As indicated above the present invention is only intended for disc brakes having a fixed caliper and one or more floating brake discs.

According to the prior art the torque plate of a disc brake having a fixed caliper is normally attached to one end surface of the caliper, by means of a number of bolts or other fastening means. As the resultant of the braking forces will act directed along the contact surface between caliper and torque plate, the fastening means will be exposed to said force resultant as a shearing force. Thus, the fastening means used for attachment to the caliper will be exposed to large forces. For brakes having a torque plate with traditional design the fixation means for fixation of the torque plate to the caliper are weak parts. They are weak in the sense that the fastening means often failure after extended use or if the brake experience large braking forces.

### THE INVENTION

A general desire when designing new brakes is to reduce the weight, the space needed by the brake and the costs for production and maintenance. There is also a desire to facilitate assembly and mounting of the brake.

One object of the present invention is to design a torque plate and caliper less sensitive to stress. Further—more, one object of the present invention is that the torque plate should take up the force of braking in a concentrated and centralized way from the caliper.

Further objects are that the brake should have a low weight and that it should be relatively easy to produce, assembly, mount and maintain.

According to the invention a torque plate is arranged for cooperation with a fixed caliper of a disc brake. Said torque plate has a first part extended in a generally longitudinal direction and a central through opening. Two angled parts of the torque plate are arranged at each end of the first longitudinal part. Each angled part has a raised portion, on which a support surface is arranged for forming a contact surface with the caliper. Each contact surface has a generally horizontal orientation and a friction to reduce the stress on fixation means for fixation of the torque plate.

With the design of the torque plate according to the present invention the forces at braking are taken up in a more favorable way compared to previously used torque plates. The force from the caliper is transferred to the torque plate in a contact surface, having a generally horizontal orientation and a certain friction. Thus, the friction of the contact surface is normally increased compared to what is ordinarily in connection with brakes. A person skilled in the art knows that there are different possibilities to enhance the friction. It may be done by less surface machining or treatment than usually, by friction enhancing treatment, such as roughing mechanically or by adding material etc. The previously known brakes with fixed caliper had a contact surface with a generally vertical orientation. The resultant of the braking forces acted in a direction along the contact surface between caliper and torque plate, thus the fastening means for attaching the torque plate to the caliper experienced a large shearing force in breaking.

According to the present invention the direction of the resulting forces at breaking will be directed cross the contact surface between caliper and torque plate. Thus, by said orientation of the contact surface according to the present invention the shearing force on the fixation means for fixation of the torque plate is reduced. The friction at the contact surface will also assist in reducing the demands on the fixation means. The friction will be increased in that the contact surface is inclined. By the use of a torque plate according to the present invention, the distribution of the braking forces is improved and the demands on the fixation means are decreased. Thus, the dimension of the torque plate and the dimension and/or number of the fixation means may be decreased, which means a cost and weight saving and, thus, also saving of space.

By the present invention the torque plate is designed in view of the expected distribution of forces in braking.

The contact surface between caliper and torque plate is concentrated to the crucial area concerning the force distribution.

By the invention it is possible to make the caliper and torque plate of different materials. It is e.g. possible to make the torque plate of a weldable material, to select material to reduce weight, occupied space etc.

Even though only part of the brake is described a person skilled in the art realizes that the brake comprises further parts such as a brake mechanism, one or more brake discs, brake pads etc. But as these parts form no part of the present invention they will not be described further here.

The expressions “horizontal”, “vertical” and expressions of similar character as used in this description should be read in relation to the orientation as shown in the Figs. A person skilled in the art realizes that in use the brakes may be orientated somewhat differently. The expression “axial” as used in this description is in relation to the wheel axle (not shown) to be received in the torque plate.

### BRIEF DESCRIPTION OF THE DRAWINGS

The invention will be described further below by way of an example and with reference to the enclosed drawings.

In said drawings:

FIG. 1 is a perspective view of a torque plate according to the present invention and

FIG. 2 is a perspective view of an alternative torque plate for co-operation with a caliper.

### DETAILED DESCRIPTION OF PREFERRED EMBODIMENTS

In the drawings a torque plate 1 is shown supporting a caliper 2. The caliper is more or less a standard caliper. The caliper 2 has a part 4 for receiving a brake mechanism (not shown) and an opening in which the brake discs and pads (not shown) are to be received. The caliper 2 is to be placed on top of the torque plate 1.

The torque plate 1 has a generally longitudinal first part 8, in which a central through opening 3 is placed. The through opening 3 is to receive a wheel axle (not shown).

Furthermore, the torque plate 1 has two angled parts 9 at each end of the first part 8 of the torque plate 1. Said two angled parts 9 extend approximately at right angles from the first part 8 and in the same general direction.

At the end of each of the angled parts 9 there is a raised portion having a support surface 6 for cooperation with a corresponding surface 5 on the lower side of the caliper 2. In the shown embodiment the support surfaces 6 are slightly inclined towards each other. Expressed differently the support surfaces 6 are inclined in a direction directed towards the wheel axle (not shown) to be received in the central through opening 3 of the torque plate 1.

This will give a more stable connection of the caliper 2 to the torque plate 1, compared to if said support surfaces 6 are not inclined. The corresponding surfaces of the caliper 2 will have the same inclination as the support surfaces 6 of the torque plate 1. A person skilled in the art realizes that the support surfaces 6 of the torque plate 1 may have different inclinations, as long as the corresponding surfaces of the caliper 2 are given the same inclination. The caliper 2 is kept in position in relation to the torque plate 1 by means of the friction at said support surfaces 6 and also the inclination of the support surface. The friction is enhanced during braking due to the distribution of the braking forces.

The support surfaces 6 are given an axial position corresponding to the calculated position for the resultant of the forces generated during braking. Said position may vary somewhat depending on the wear of the brake pads. However, the support surfaces 6 are given an axial length and are positioned in such a way that the resultant will always be placed somewhere along the support surface 6. The aim is that the centre, in axial direction, of the support surface 6 should coincide with the position of the force resultant.

In practice this means that the support surfaces 6 are placed approximately at the middle of the caliper 2.

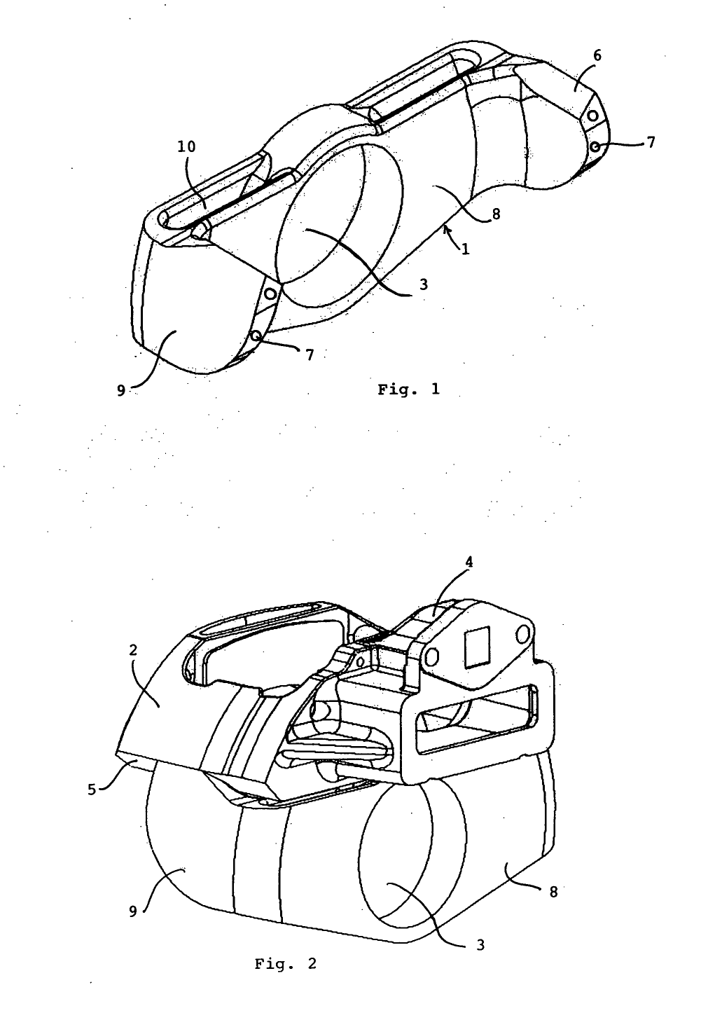

Furthermore, in the embodiment of FIG. 1 the angled parts 9 have openings 7 at the end directed away from the torque plate 1. Said openings 7 are to receive bolts or the like for fixation of the torque plate 1 to the caliper 2.

For the torque plate 1 of FIG. 1 the caliper will have parts (not shown) that are extended along the surfaces of the torque plate 1 having the openings 7. Thus, the torque plate 1 will be fixed to the caliper 2 by means of suitable fastening means, e.g. screws, received in the openings 7.

In the embodiment of FIG. 2 the torque plate 1 is furnished with openings (not shown) to receive suitable fastening means, e.g. screws. The fastening means are to be received in openings (not shown) of the caliper 2, placed in the surface in contact with the support surfaces 6 of the torque plate 1. Thus, in this latter case the fastening means will go through the contact surface between caliper 2 and torque plate 1. A person skilled in the art realizes that the torque plate 1 may be fixed to the caliper 2 in many different ways.

The torque plate 1 may be furnished with recesses 10 as indicated in FIG. 1. The purpose of the recesses 10 is mainly to save weight.

1. A torque plate (1) for co-operation with a fixed caliper (2) of a disc brake, which torque plate (1) has a first part (8) extended in a first longitudinal direction and having a central through opening (3), said first direction being perpendicular to the axial direction of a wheel axle to be received in the opening (3), wherein two angled parts (9) are arranged at each end of said first longitudinal part (8) and each having a raised portion, characterized in that a support surface (6) is arranged on each raised portion for forming a contact surface with the caliper (2) and that each contact surface has a generally horizontal orientation and a friction to reduce the stress on fixation means for fixation of the torque plate (1).

2. The torque plate (1) of claim 1, characterized in that the angled parts (9) extend in the same general direction at approximate right angles to the first longitudinal part (8).

3. The torque plate of claim 1 or 2, characterized in that each support surface (6) of the torque plat (1) is inclined, directed towards the wheel axle to be received in the central through opening (3).

4. The torque plate of any of the previous claims, characterized in that the caliper (2) is placed on top of the support surfaces (6) of the torque plate (1).

5. The torque plate of any of the previous claims, characterized in that the axial length of each support surface (6) is less than the axial extent of the caliper (2).

6. The torque plate of any of the previous claims, characterized in that the support surfaces (6) are given an axial position corresponding to a calculated position for the resultant of the braking forces and that the support surfaces (6) have an axial length at least corresponding to the position of the resultant of braking forces as brake pads of the brake wear.

7. The torque plate of claim 6, characterized in that the position of the resultant of the braking forces coincide with the center, in axial direction, of the support surfaces (6).

8. The torque plate (1) of any of the previous claims, characterized in that the angled parts (9) are furnished with holes (7) for receiving fixation means for fixation of the torque plate (1) to the caliper (2).
